(19) United States
(12) Patent Application Publication
(10) Pub. No.: US 2026/0024417 A1
(43) Pub. Date: Jan. 22, 2026

(54) CLAW MACHINE

(71) Applicant: PAOKAI ELECTRONIC ENTERPRISE CO., LTD., Kaohsiung City (TW)

(72) Inventors: Ming-Shan WEI, Kaohsiung City (TW); Tung-Ying WEI, Kaohsiung City (TW)

(21) Appl. No.: 18/950,539

(22) Filed: Nov. 18, 2024

(30) Foreign Application Priority Data
Jul. 16, 2024 (TW) 113126606

(51) Int. Cl. G07F 17/32; A63F 9/30; G07F 9/02

(52) U.S. Cl. CPC G07F 17/3297; A63F 9/30; G07F 9/02; G07F 17/3202; G07F 17/3246

(57) ABSTRACT

A claw machine has an object placed therein, and includes a cabinet, an operating unit, a sensing unit and a control unit. The cabinet defines an inner space that allows the object to be placed therein, and has an output hole that is in spatial communication with the inner space and that is for retrieving the object. The operating unit is disposed in the inner space, and includes a moving mechanism, and a claw mechanism that is movably connected to the moving mechanism and that is configured to grab the object. The sensing unit is disposed to detect a status of the object, thereby generating reference information. The control unit is electrically connected to the claw mechanism and the sensing unit, and is configured to adjust at least one parameter of the claw mechanism based on the reference information.

### CROSS-REFERENCE TO RELATED APPLICATION

This application claims priority to Taiwanese Invention Patent Application No. 113126606, filed on Jul. 16, 2024, the entire disclosure of which is incorporated by reference herein.

### FIELD

The disclosure relates to a game machine, and more particularly to a claw machine.

### BACKGROUND

Referring to FIG. 1, a conventional claw machine 1 includes a cabinet 10 that defines an inner space 100 allowing a plurality of objects (not shown) to be placed therein, a claw mechanism 11 that is disposed in the inner space 100 and that is configured to grab any of the objects, and an operating interface 12 that is connected to the cabinet 10 and that is configured to be operated to control movement of the claw mechanism 11. In practice, after inserting a coin into the conventional claw machine 1, a player may operate the claw mechanism 11 through the operating interface 12 to grab any of the objects in the inner space 100. When performing maintenance for the conventional claw machine 1, an owner of the claw machine 1 may need to place the objects in the inner space 100, and to adjust the claw mechanism 11 based on the shapes, sizes, and/or weights of the objects.

The objects that are placed in the inner space 100 of the claw machine 1 may serve as a direct reference for the player to decide whether the claw machine 1 appears attractive to be played. However, even if the objects lure the player into playing, if the player then determines that the grabbing mode of the claw mechanism 11 makes it difficult to successfully grab any of the objects, the player may stop playing. It is important to adjust the claw mechanism 11 in such a manner that a difficulty of successfully grabbing the objects is balanced between the owner profiting and the players maintaining their interest in playing, where it is not too easy, nor is it too difficult, for the player to successfully obtain the objects, so that the player may be willing to continue trying.

A type of the objects placed in the inner space 100 may be changed by the owner over time, and operation of the claw mechanism 11 may be affected due to its components deteriorating over time. Therefore, the owner may need to periodically and dynamically readjust the claw mechanism 11 based on the type of the objects, a rate of success of the objects being obtained, or how players operate the claw mechanism 11, so the difficulty is well balanced. However, sometimes when the claw mechanism 11 is not adjusted properly, the rate of success of the objects being obtained by the player may exceed the owner's expectation, and if the owner is unable to timely adjust the claw mechanism 11, the owner may lose money.

### SUMMARY

Therefore, an object of the disclosure is to provide a claw machine that can alleviate at least one of the drawbacks of the prior art.

According to the disclosure, a claw machine has an object placed therein, and includes a cabinet, an operating unit, a sensing unit and a control unit. The cabinet defines an inner space that allows the object to be placed therein, and has an output hole that is in spatial communication with the inner space and that is for retrieving the object. The operating unit is disposed in the inner space, and includes a moving mechanism and a claw mechanism that is movably connected to the moving mechanism and that is configured to grab the object. The sensing unit is disposed to detect a status of the object, thereby generating reference information. The control unit is electrically connected to the claw mechanism and the sensing unit, and is configured to adjust at least one parameter of the claw mechanism based on the reference information.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a front view illustrating a conventional claw machine.

FIG. 2 is a schematic view illustrating a claw machine according to an embodiment of the disclosure.

FIG. 3 is a plot illustrating reference information obtained by a sensing unit of the claw machine during a process of a claw mechanism of the claw machine grabbing an object, where the sensing unit is an optical sensor.

FIG. 4 is a plot illustrating the reference information obtained by the sensing unit during the process of the claw mechanism grabbing an object, where the sensing unit is a distance sensor.

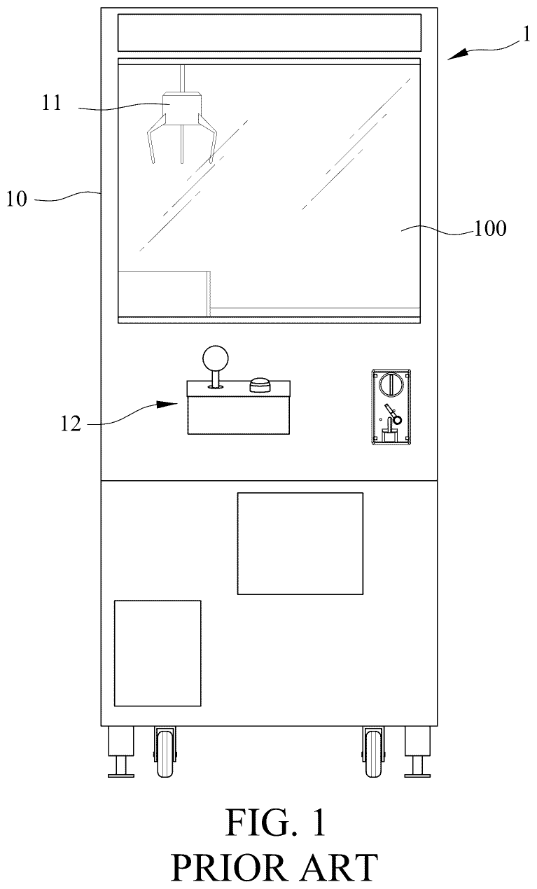

### DETAILED DESCRIPTION

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

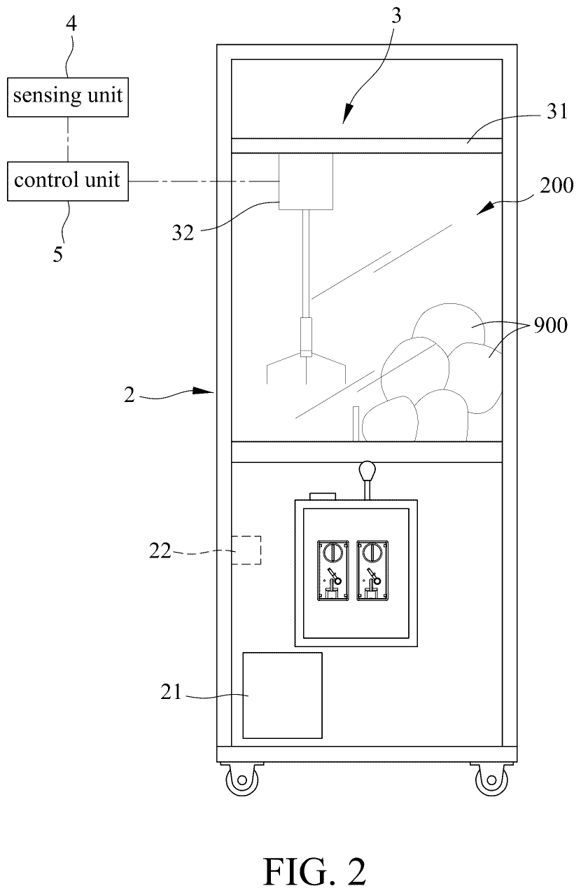

Referring to FIG. 2, a claw machine according to an embodiment of the disclosure includes a cabinet 2 that defines an inner space 200 allowing a plurality of objects 900 to be placed therein, an operating unit 3 that is disposed in the inner space 200, a sensing unit 4, and a control unit 5 that is electrically connected to the operating unit 3 and the sensing unit 4. In this embodiment, the sensing unit 4 is disposed to be spaced apart from the operating unit 3; in some embodiments, the sensing unit 4 is disposed inside the claw machine, in some embodiments, the sensing unit 4 is disposed outside the claw machine, and in some embodiments, the sensing unit 4 is attached to the operating unit 3. In some embodiments, there may be only one object 900 being placed in the inner space 200, but this disclosure is not limited in this respect.

The cabinet 2 has an output hole 21 that is in spatial communication with the inner space 200 and that is for retrieving any of the objects 900, and includes an object sensor 22 that is disposed in the output hole 21 and that is configured to determine whether any of the objects 900 has passed by the object sensor 22 (i.e., has been dropped from the inner space 200 to the output hole 21). In one example, the object sensor 22 adopts an optical determination mechanism (e.g., a photo interrupter), and generates a detection signal when determining that any of the objects 900 has passed through the output hole 21 (i.e., has passed by the object sensor 22), where the detection signal is sent to the control unit 5.

The operating unit 3 includes a moving mechanism 31 (e.g., a gantry mechanism) that is mounted in a top portion of the inner space 200, and a claw mechanism 32 that is movably connected to the moving mechanism 31 and that is configured to grab any of the objects 900. In one example, the claw mechanism 32 includes a driving coil, of which one or more relevant electrical parameters (e.g., electric current provided to the driving coil) may be adjusted to control a claw to grip or to release, and to adjust a grip strength of the claw.

In this embodiment, the sensing unit 4 is disposed apart from the claw mechanism 32 of the operating unit 3, and is configured to detect a status of a target object that is any of the objects 900 corresponding in position to the claw mechanism 32, thereby generating reference information. For example, the target object may be any of the objects 900 that is to be grabbed by the claw mechanism 32 (e.g., an object 900 that is directly below the claw mechanism 32), any of the objects 900 that is being grabbed by the claw mechanism 32, or any of the objects 900 that is just released by the claw mechanism 32. In some embodiments, the sensing unit 4 is an optical sensor, and the reference information indicates whether any of the objects 900 is grabbed by the claw mechanism 32. In some embodiments, the sensing unit 4 is a distance sensor that is disposed on the claw mechanism 32, and the reference information indicates a distance between the claw mechanism 32 and the target object (e.g., one of the objects 900 that is the closest to the claw mechanism 32). In some embodiments, the sensing unit 4 is an image recognition system that may be disposed apart from the claw mechanism 32, and the reference information indicates a distance between the claw mechanism 32 and the target object determined by the image recognition system.

The control unit 5 is configured to adjust at least one parameter of the claw mechanism 32 based on the reference information. To describe in further detail, the control unit 5 may be a software, a hardware, and/or a firmware device that is capable of performing calculations and controlling operation of the operating unit 3 based on the reference information. In this embodiment, the control unit 5 may be implemented by a central processing unit (CPU), a microcontroller (MCU), or any circuit capable of implementing functionalities of this disclosure. In some embodiments, logic programs may be written into the control unit 5 to achieve the abovementioned functions. In some embodiments, the control unit 5 may operate cooperatively with an artificial intelligence system that is configured to automatically improve or extend control logics of the control unit 5 during a process of the control unit 5 receiving the reference information and outputting operation commands to the operating unit 3 for multiple times.

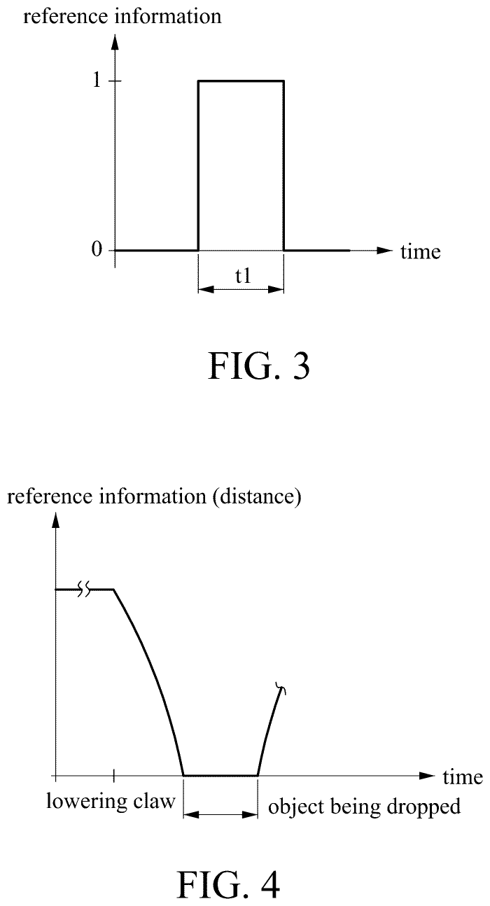

Referring further to FIG. 3, when the sensing unit 4 is an optical sensor, the reference information is illustrated by a first plot, where a y-axis of the first plot indicates whether any of the objects 900 is being grabbed by the claw mechanism 32 (e.g., “1” indicates that the claw mechanism 32 is grabbing an object 900, and “0” indicates that the claw mechanism 32 is not grabbing any object 900), and where an x-axis of the first plot indicates a time axis. Using the first plot shown in FIG. 3 as an example, the reference information represents a process of the claw mechanism 32 lowering the claw, the claw mechanism 32 grabbing the target object (i.e., one of the objects 900), and the target object being dropped from the claw after the target object has been grabbed for a first time period (t1). The control unit 5 may then determine whether the object 900 grabbed by the claw mechanism 32 has passed through the output hole 21 based on whether the detection signal is received from the object sensor 22, or based on whether the first time period (t1) is longer than a threshold value. In one example, when the first time period (t1) is longer than the threshold value, it means that the first time period (t1) is sufficient for the claw mechanism 32 to move to be above the output hole 21 and thus the object 900 may be dropped into the output hole 21.

In this embodiment, the at least one parameter of the claw mechanism 32 includes the grip strength of the claw, and the control unit 5 may determine whether the grip strength of the claw is too weak or too strong based on the reference information. To describe in further detail, in one example, if the first time period (t1) is excessively short (e.g., is shorter than a first predetermined length of time, which may be shorter than or equal to the aforesaid threshold value), the control unit 5 may determine that the grip strength is too weak such that the target object was quickly dropped from the claw mechanism 32 after being grabbed by the claw; if the first time period (t1) is excessively long (e.g., is longer than a second predetermined length of time, which may be longer than or equal to the aforesaid threshold value), the control unit 5 may determine that the grip strength is too strong such that it is too easy for the claw mechanism 32 to grab the object 900 and to move a distance that is long enough for dropping the target object into the output hole 21. In some embodiments, the control unit 5 is configured to, after each game, adjust the grip strength of the claw when determining that the grip strength is too weak or too strong based on the reference information generated from the game (i.e., after a process of the claw mechanism 32 being operated to grab any of the objects 900 and to move toward the output hole 21). In some embodiments, the control unit 5 is configured to, while the game is in progress, adjust the grip strength of the claw when determining that the grip strength is too weak or too strong based on the reference information generated from the game. As such, the control unit 5 is able to dynamically adjust the grip strength of the claw in order to balance a difficulty of the game.

In some embodiments, the at least one parameter of the claw mechanism 32 includes a duration of the grip strength. In one example, the grip strength of the claw is fixed to be at a predetermined grip strength, and when determining that the first time period (t1) is too short or too long based on the reference information generated from the game, the control unit 5 may adjust the duration of the claw maintaining at the predetermined grip strength, so as to increase or decrease the first time period (t1) for the next game. In another example, the control unit 5 may adjust the grip strength (i.e., increase or decrease the grip strength) in addition to adjusting the duration of the grip strength, which is more in line with the way an experienced person adjusts the claw mechanism 32.

Referring further to FIG. 4, when the sensing unit 4 is a distance sensor, the reference information is illustrated by a second plot, where a y-axis of the second plot indicates a distance from the claw mechanism 32 to the target object, and where an x-axis of the second plot indicates a time axis. In this embodiment, the reference information indicates the distance to the target object regarding the process of the game, which may have high reference value for the control unit 5 to precisely adjust the parameter(s) (e.g., the grip strength, the duration of the grip strength, etc.) of the claw mechanism 32.

Referring back to FIG. 2, in another embodiment where the sensing unit 4 is the image recognition system, the sensing unit 4 may be further configured to obtain a video of the process of the game as the reference information. Similarly, the control unit 5 may adjust the grip strength and/or the duration of the grip strength based on the reference information. In one example, the video may include information such as how the target object was dropped, when the target object was dropped, how long the claw contacted the target object, and/or whether the target object was dropped to the output hole 21, so the control unit 5 may perform detailed analysis on the process of the game. In a case where the control unit 5 has a self-learning function, the claw mechanism 32 may be automatically adjusted in real time, which may support an owner of the claw machine more efficiently. In one example, the self-learning function of the control unit 5 is realized using artificial intelligence, which is configured to record historical data including adjustments that are performed by the owner and that correspond to different situations, and to automatically perform adjustments based on the historical data. In this embodiment, the image recognition system includes a camera and a processor to execute an image recognition algorithm.

In summary, according to the disclosure, the control unit 5 is configured to automatically and timely adjust the claw mechanism 32 based on the reference information obtained by the sensing unit 4, and may be helpful in supporting the owner to adjust the claw mechanism 32.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A claw machine having an object placed therein, comprising:
a cabinet defining an inner space that allows the object to be placed therein, and having an output hole that is in spatial communication with said inner space and that is for retrieving the object;
an operating unit disposed in said inner space and including a moving mechanism and a claw mechanism that is movably connected to said moving mechanism and that is configured to grab the object;
a sensing unit disposed to detect a status of the object, thereby generating reference information; and
a control unit electrically connected to said claw mechanism and said sensing unit, and configured to adjust at least one parameter of said claw mechanism based on the reference information.

2. The claw machine as claimed in claim 1, wherein said sensing unit is an optical sensor that is configured to detect whether the object is grabbed by said claw mechanism.

3. The claw machine as claimed in claim 2, wherein the at least one parameter includes a grip force of said claw mechanism.

4. The claw machine as claimed in claim 3, wherein the at least one parameter further includes a duration related to the grip force of said claw mechanism.

5. The claw machine as claimed in claim 4, wherein said cabinet further includes an object sensor that is disposed in said output hole and that is configured to determine whether the object has passed by said object sensor.

6. The claw machine as claimed in claim 3, wherein said cabinet further includes an object sensor that is disposed in said output hole and that is configured to determine whether the object has passed by said object sensor.

7. The claw machine as claimed in claim 1, wherein said sensing unit is a distance sensor that is configured to detect a distance between said claw mechanism and the object.

8. The claw machine as claimed in claim 7, wherein the at least one parameter includes a grip force of said claw mechanism.

9. The claw machine as claimed in claim 8, wherein the at least one parameter further includes a duration related to the grip force of said claw mechanism.

10. The claw machine as claimed in claim 9, wherein said cabinet further includes an object sensor that is disposed in said output hole and that is configured to determine whether the object has passed by said object sensor.

11. The claw machine as claimed in claim 8, wherein said cabinet further includes an object sensor that is disposed in said output hole and that is configured to determine whether the object has passed by said object sensor.

12. The claw machine as claimed in claim 1, wherein said sensing unit is an image recognition system that is configured to obtain a video of a process of the object being grabbed by said claw mechanism.

13. The claw machine as claimed in claim 12, wherein the at least one parameter includes a grip force of said claw mechanism.

14. The claw machine as claimed in claim 13, wherein the at least one parameter further includes a duration related to the grip force of said claw mechanism.

15. The claw machine as claimed in claim 14, wherein said cabinet further includes an object sensor that is disposed in said output hole and that is configured to determine whether the object has passed by said object sensor.

16. The claw machine as claimed in claim 13, wherein said cabinet further includes an object sensor that is disposed in said output hole and that is configured to determine whether the object has passed by said object sensor.

17. The claw machine as claimed in claim 1, wherein the at least one parameter includes a grip force of said claw mechanism.

18. The claw machine as claimed in claim 17, wherein the at least one parameter further includes a duration related to the grip force of said claw mechanism.

19. The claw machine as claimed in claim 18, wherein said cabinet further includes an object sensor that is disposed in said output hole and that is configured to determine whether the object has passed by said object sensor.

20. The claw machine as claimed in claim 17, wherein said cabinet further includes an object sensor that is disposed in said output hole and that is configured to determine whether the object has passed by said object sensor.
